(19) United States
(12) Patent Application Publication
(10) Pub. No.: US 2022/0288431 A1
(43) Pub. Date: Sep. 15, 2022

(54) ADJUSTABLE-LENGTH LANYARD, ROPING HARNESS, ROPE ASCENT DEVICE AND METHOD FOR USE

(71) Applicant: ZEDEL, Crolles (FR)

(72) Inventors: Jean-Marc HEDÉ, Domène (FR); Benoît ROGER, Saint Pancrasse (FR)

(73) Assignee: ZEDEL, Crolles (FR)

(21) Appl. No.: 17/679,328

(22) Filed: Feb. 24, 2022

(30) Foreign Application Priority Data
Mar. 10, 2021 (FR) 2102340

(51) Int. Cl. A62B 35/00

(52) U.S. Cl. CPC A62B 35/0093; A62B 35/0018

(57) ABSTRACT

A lanyard comprises a wire-like element with two ends. A reel with a spring is provided with a rotor that is movable with respect to a stator in two directions of rotation. The wire-like element is fixed to the rotor to be wound or unwound. A clamp is fitted movable between a position where the clamp is at a distance from the textured contact area to allow rotation of the rotor and a position where the clamp is in contact with the textured contact area to prevent rotation of the rotor. The clamp is mounted movable with respect to the stator to move under the effect of its weight according to the incline of the stator with respect to the gravity vector to move the clamp between the two positions.

### BACKGROUND OF THE INVENTION

The invention relates to a lanyard of adjustable length, to a roping harness, to a rope ascent device and to its method for use.

### PRIOR ART

In a large number of rope access work situations, the rope access technician may need to use tools that are attached to the harness, for example a hammer, a punch or a saw. The rope access technician uses a tool that is secured to the harness as a safety measure. The tool is secured by means of a lanyard the length of which is chosen so that the user can use the tool with all the required amplitude of his movements. When the lanyard is attached to the belt, the lanyard generally has a length that is equivalent to the distance between the user's hip and hand when his arm is stretched upwards.

When the rope access technician is not using the tool, the latter is hanging from its attachment point. The tool then has to be hauled up by pulling on the lanyard. If several tools are used, they may dangle underneath the rope access technician and get caught up with one another. As an alternative, it is possible to tie a knot in the lanyard to reduce the effective length of the lanyard. The knots then have to be regularly tied and undone.

Elastic lanyards are known that can elongate when pulled on. The gain procured by this technical solution is slight for when the tool is heavy, as can be the case with a punch or a chain saw, the lanyard is stretched taut by the weight of the tool. If the stiffness of the elastic element is increased to avoid the lanyard being totally stretched with heavy tools in extension, the rope access technician has to make an effort to stretch the lanyard which tires him and/or makes his movement less precise.

A problem of similar nature exists for people who regularly perform rope ascent operations. It is conventional to use a foot loop formed by a lanyard. The top end of the lanyard is fixed to the rope by a clamp and the bottom end defines a loop. The user places his foot in the foot loop and presses in the loop to ascend along the rope and move his attachment point on the rope upwards. The foot loop has a length that is adjusted to the size of its user and is only used during rope ascent phases. Between these phases, the length of the lanyard hampers the user which incites him to tie a knot in the lanyard to reduce its bulk or stow it away in a bag with the risk of it getting tangled up. There again, the elastic lanyard is not an advantageous solution, for when the foot leaves the foot loop, the lanyard retracts which means that the user has to start stretching it with his hands before he can place his foot in it. As the user is pressing down with all his weight to ascend along the rope, the elastic material has to be chosen accordingly, or it has to be doubled up by a strengthened portion which increases its bulk.

### OBJECT OF THE INVENTION

One object of the invention consists in providing a lanyard of adjustable length that is more practical to use than the prior art configurations. For this purpose, the adjustable-length lanyard comprises:
a wire-like element having a first end and a second end opposite the first end;
a reel comprising a rotor, a stator and a spring, the rotor being mounted rotatable with respect to the stator in two opposite directions of rotation, at least the second end of the wire-like element exiting from the reel, the wire-like element being functionally linked to the rotor so that rotation of the rotor results in winding of the wire-like element and that unwinding of the wire-like element makes the rotor rotate, rotation of the rotor modulating the effective distance between the first end and the second end of the wire-like element, and so that if no force is applied on the wire-like element, the spring linked to the rotor and to the stator causes winding of the wire-like element;
an attachment point designed to secure the lanyard to another element.

The adjustable-length lanyard is remarkable in that:
a textured contact area is fixed to the rotor;
a clamp is fitted movable between a first clamp position and a second clamp position, the first clamp position corresponding to one of the clamp positions chosen from the clamp in contact with the textured contact area to block rotation of the rotor in at least a first of the two directions of rotation and the clamp at a distance from the textured contact area to allow rotation of the rotor at least in the first of the two directions of rotation, the second clamp position corresponding to the other of the two clamp positions;
a mass mounted movable with respect to the rotor and to the stator, the mass moving under the effect of its weight according to the incline of the stator with respect to the gravity vector, the mass being functionally linked to the clamp so that movement of the mass results in movement of the clamp between the first clamp position and the second clamp position and that movement of the clamp results in movement of the mass.

According to one embodiment, the reel is able to rotate in the two opposite directions of rotation when the clamp is at a distance from the textured contact area.

Advantageously, the textured contact area defines asymmetric teeth and/or the clamp defines an asymmetric head in a cutting plane perpendicular to the axis of rotation of the rotor to allow rotation of the rotor with respect to the stator in the other of the two directions of rotation when the clamp is in contact with the textured contact area.

In one development, the textured contact area is mounted rotatable with respect to the rotor when a force applied between the rotor and the textured contact area is greater than a threshold force so as to allow rotation of the rotor in the at least one of the two directions of rotation when the clamp is in contact with the textured contact area.

Preferentially, the rotor is provided with a ring that has an outer crown and an inner crown, one of the inner crown and outer crown forming the textured contact area, the other of the inner crown and outer crown forming a mechanical disconnection device with the rotor when a threshold force is reached.

In a particular embodiment, the rotor and the other of the inner crown and outer crown define a first set of teeth and a second set of teeth, the first set of teeth and/or the second set of teeth being elastically deformable.

Advantageously, the clamp is mounted movable in translation in a slide or the clamp is mounted rotatable around a rotation shaft.

In preferential manner, the clamp and the mass are monolithic or in a single piece.

In an advantageous configuration, the stator defines a first outlet opening for the first end of the wire-like element and a second outlet opening of the second end, the first and second outlet openings being diametrically opposite in the direction of a diameter of the rotor. The mass moves mainly or exclusively along an axis parallel to the axis connecting the first and second outlet openings.

In a particular embodiment, the wire-like element passes through a slot of the rotor, and when the wire-like element is fully stretched between the first end and the second end, the reel is movable along the wire-like element.

It is particularly advantageous to provide for the first end of the wire-like element to form a ring around the rotor and to be fixed to the rotor and a second wire-like element to be fixed to the stator. The second wire-like element has a second end forming a second loop passing through the first loop and through the rotor, rotation of the rotor not having any influence on elongation or shortening of the second wire-like element.

It is a further object of the invention to provide a roping harness equipped with a gear sling lanyard that is easier to use than the prior art configurations. The roping harness comprises a variable-length lanyard according to any one of the foregoing configurations. The attachment point is fixed to an anchor ring of the roping harness.

In a particular embodiment, a tool is fixed to the second end of the wire-like element, the first end of the wire-like element exiting from the stator via a first opening and the second end of the wire-like element exiting the stator via a second opening, and in which the clamp is arranged to block the rotor when the second opening is higher up than the first opening.

Preferentially, a tool is fixed to the second end of the wire-like element, the second end of the wire-like element exiting from the stator via a second opening. The clamp is arranged to block rotation of the rotor in the first direction of rotation when the vector connecting the axis of rotation of the rotor and the second opening is directed upwards, and to allow rotation of the rotor in the first direction of rotation when the vector connecting the axis of rotation of the rotor and the second opening is directed downwards, the first direction of rotation corresponding to winding of the wire-like element.

It is a further object of the invention to provide a method for use a roping harness that is easier to use than the roping harness having gear sling lanyards of the prior art.

This result tends to be achieved by means of a method for using a roping harness according to one of the foregoing configuration comprising at least the following steps:
providing said roping harness;
directing the stator downwards so that the clamp blocks the rotor to prevent unwinding of the wire-like element;
directing the stator upwards so that the clamp unblocks the rotor and pulling on the wire-like element to unwind the wire-like element from the rotor and to move the first end away from the second end.

It is a further object of the invention to provide a rope ascent device that is easier to use than the devices of the prior art.

The rope ascent device comprises a rope clamp designed to be fixed to a rope and a variable-length lanyard according to any one of the foregoing configurations. The rope clamp is fixed to the attachment point of the variable-length lanyard and a ring designed to receive the foot of a rope access technician is fixed to or is formed by the second end of the wire-like element, the second end exiting from the stator via a second opening. The clamp is arranged to block rotation of the rotor in the first direction of rotation when the vector connecting the axis of rotation of the rotor and the second opening is directed downwards, and to allow rotation of the rotor in the first direction of rotation when the vector connecting the axis of rotation of the rotor and the second opening is directed upwards, the first direction of rotation corresponding to winding of the wire-like element.

As an alternative, the rope ascent device comprises a rope clamp designed to be fixed to a rope and a variable-length lanyard according to any one of the foregoing configurations. The rope clamp is fixed to the second end of the wire-like element and a ring designed to receive a rope access technician's foot is fixed to or is formed by the attachment point of the variable-length lanyard, the second end exiting from the stator via a second opening. The clamp is arranged to block rotation of the rotor in the first direction of rotation when the vector connecting the axis of rotation of the rotor and the second opening is directed upwards, and to allow rotation of the rotor in the first direction of rotation when the vector connecting the axis of rotation of the rotor and the second opening is directed downwards, the first direction of rotation corresponding to winding of the wire-like element.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a perspective view of a lanyard with the stator cover;

FIG. 2 schematically illustrates a perspective view of a lanyard without the stator cover;

FIG. 3 schematically illustrates a top view of a first embodiment of a lanyard without the stator cover, without the textured contact area and without the mechanical disconnection device;

FIG. 4 schematically illustrates a perspective view of the reel of FIG. 3, of the first embodiment of the lanyard without the stator cover, the textured contact area, the mechanical disconnection device and the wire-like element;

FIG. 5 schematically illustrates a perspective view of the reel of FIG. 3, of the first embodiment of the lanyard without the stator cover, the textured contact area, the mechanical disconnection device and the top part of the rotor;

FIG. 6 schematically illustrates a top view of the reel of FIG. 5;

FIG. 7 schematically illustrates a bottom view of the assembly formed by the top part of the rotor, the wire-like element, the spring and the clamp according to the first embodiment;

FIG. 8 schematically illustrates a perspective view of the stator support with the wire-like element according to the first embodiment;

FIG. 9 schematically illustrates a view of a second embodiment of a lanyard without the cover and without the wire-like element,

FIG. 10 schematically illustrates a perspective view of a roping harness connected to a lanyard forming a gear sling lanyard;

FIG. 11 schematically illustrates a rope ascent device comprising a variable-length lanyard;

FIG. 12 schematically illustrates a perspective view of another embodiment of a reel without the support with its wire-like element and its spring;

FIG. 13 schematically illustrates another perspective view of the reel according to FIG. 12 without the support and its wire-like element.

### DESCRIPTION OF THE EMBODIMENTS

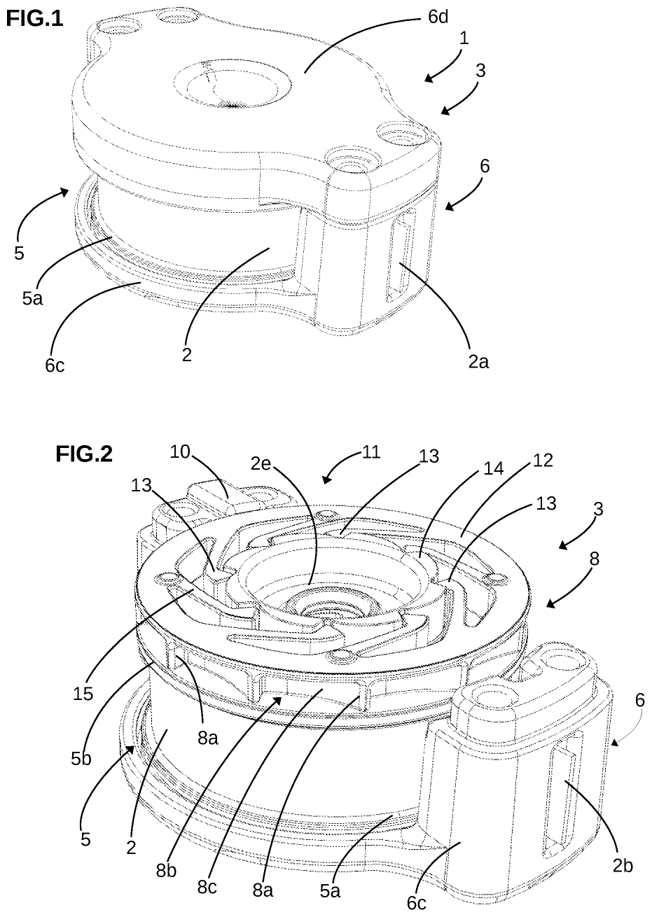

FIGS. 1 to 9 illustrate a lanyard 1 that is an adjustable-length lanyard. Lanyard 1 has a wire-like element 2 having a first end 2a and a second end 2b located opposite first end 2a. When fully stretched, wire-like element 2 has a first length that separates first end 2a and second end 2b. Lanyard 1 is configured to adjust the distance separating first end 2a and second end 2b of wire-like element 2.

In the illustrated embodiments, wire-like element 2 is a strap, but it is also possible to provide a rope, a cable or any other suitable wire-like element.

In order to adjust the effective length of wire-like element 2, lanyard 1 is provided with a reel 3. Reel 3 comprises a spring 4, a rotor 5 and a stator 6. Rotor 5 is mounted rotatable with respect to stator 6 in two opposite directions of rotation. Wire-like element 2 is fixed to rotor 5 so that rotation of rotor 5 causes winding or unwinding of wire-like element 2. Rotor 5 has a direction of rotation performing winding of wire-like element 2 and a direction of rotation performing unwinding of wire-like element 2. Rotation of rotor 5 makes the effective distance between first end 2a and second end 2b vary. At least second end 2b of wire-like element 2 exits from reel 3 so that rotation of rotor 5 results in second end 2b being moved towards or away from stator 6. Rotor 5 has a drum that receives wire-like element 2.

Lanyard 1 has an attachment point that is designed to secure lanyard 1 to a support means. The support means is preferentially chosen from a harness, a fixed anchor point in a wall or other element or a rope clamp. The attachment point of lanyard 1 can be one end of wire-like element 2, for example first end 2a or second end 2b, or another part.

A part of wire-like element 2 can be mounted in fixed manner on rotor 5, for example the middle or an intermediate area of wire-like element 2 is fixed to rotor 5. In this way, rotation of rotor 5 results in elongation or shortening in identical manner of the two strands of wire-like element 2 that exit from reel 3. In another alternative, first end 2a of wire-like element 2 is fixed to rotor 5 and stator 6 is fixed either directly to an anchor point or by means of a second wire-like element fixed to stator 6. This embodiment is less advantageous as the force applied on wire-like element 2 is still applied to reel 3. Reel 3 performs transfer of the force between the anchor point and second end 2b.

In the embodiment illustrated in FIGS. 1 to 8, wire-like element 2 has two strands that exit from stator 6 via two distinct openings. The first strand having first end 2a exits from stator 6 through first opening 6a whereas the second strand having the second end exits from stator 6 through second opening 6b. When first end 2a is fixed to rotor 5, stator 6 may not be provided with first opening 6a.

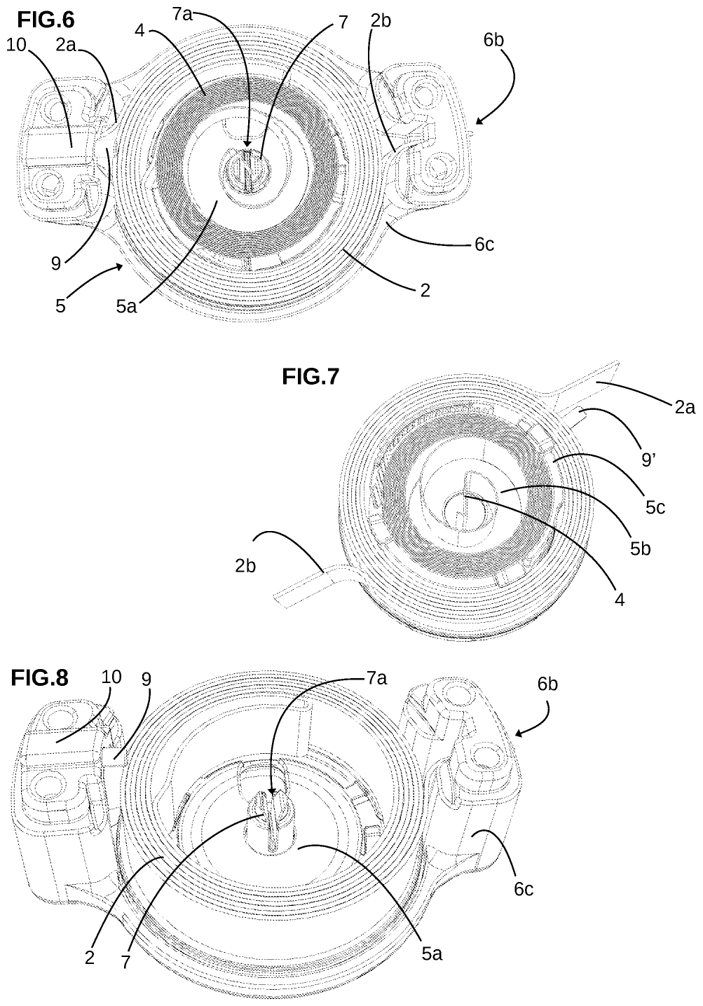

As illustrated in FIGS. 5 and 6, reel 3 has a spring 4 that is fixed on the one hand to stator 6 and on the other hand to rotor 5. Outside its equilibrium position, spring 4 is configured to make rotor 5 rotate in order to wind wire-like element 2 and therefore to reduce the effective length of wire-like element 2 as far as possible. If no force is applied on wire-like element 2, spring 4 performs winding of wire-like element 2. Spring 4 opposes movement of rotor 5 with respect to stator 6 outside its equilibrium position.

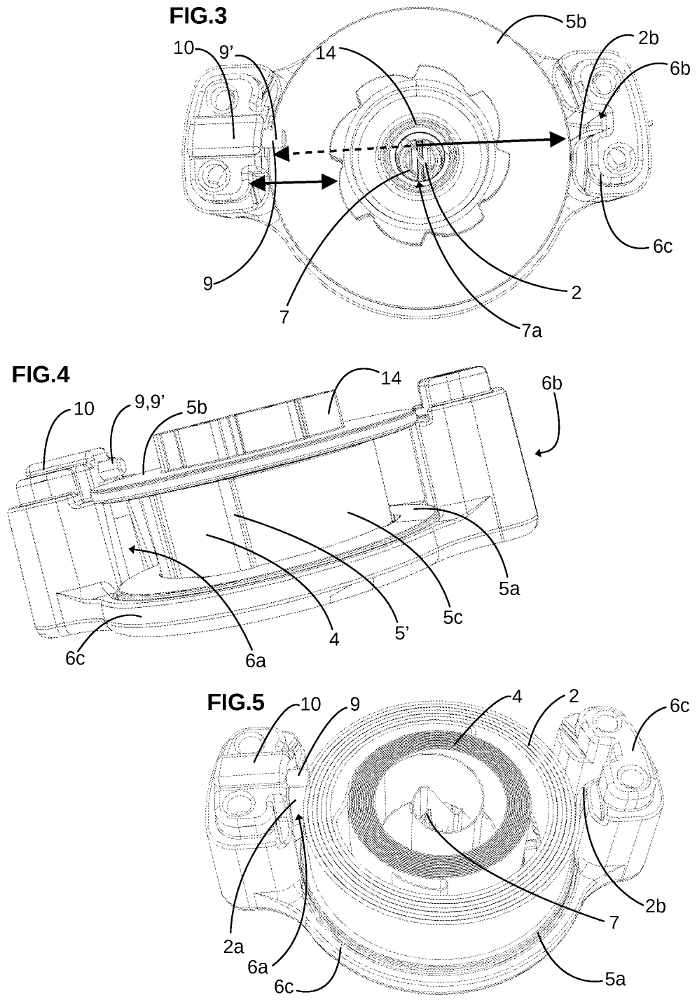

In the illustrated embodiment, spring 4 is a spiral-wound spring but other spring configurations are possible. Outside its equilibrium position, spring 4 applies a force that makes rotor 5 rotate in a direction of rotation called winding direction. In the embodiment illustrated in FIGS. 3, 5, 6 and 8, rotation shaft 7 around which rotor 5 rotates is mounted salient from support 6c of stator 6. Rotation shaft 7 defines a slot 7a and spring 4 passes inside slot 7a to be fixed to stator 6. Rotation shaft 7 is also formed by a part of cover 6d of stator 6. Other configurations are possible.

To make it easier to use, reel 3 has a blocking system provided with a textured contact area 8 cooperating with a clamp 9. Textured contact area 8 is fixed to rotor 5 or forms part of rotor 5. In a first embodiment, textured contact area 8 is mounted in fixed manner on rotor 5 so that rotation of rotor 5 makes textured contact area 8 rotate and rotation of textured contact area 8 makes rotor 5 rotate. Rotation of rotor 5 to unwind wire-like element 2 can be obtained by pulling on wire-like element 2 and by means of spring 4 to wind wire-like element 2.

Clamp 9 is mounted movable between a first clamp position and a second clamp position. Depending on the required configurations, the first clamp position corresponds to one of the clamp positions chosen from clamp 9 in contact with textured contact area 8 to prevent rotation of rotor 5 in at least a first of the two directions of rotation and clamp 9 at a distance from textured contact area 8 to allow rotation of rotor 5 at least in the first of the two directions of rotation. The second clamp position corresponds to the other of the two clamp positions.

To block rotation of rotor 5 in the first direction of rotation, clamp 9 inserts in one or more of the cavities of textured contact area 8. To allow rotation of rotor 5 in the first direction of rotation, clamp 9 is moved to a location outside the cavities.

Clamp 9 is mounted movable with respect to stator 6 and with respect to rotor 5 to define a position blocking rotor 5 with respect to stator 6 and a position allowing rotation of rotor 5 with respect to stator 6. In advantageous manner, to block rotor 5, clamp 9 presses on stator 6.

A mass 9′ is mounted free with respect to stator 6 to move under the effect of its weight according to the installation of stator 6 with respect to the gravity vector. Depending on the incline of stator 6, mass 9′ moves between a first position of mass 9′ and a second position of mass 9′. Mass 9′ is functionally connected to clamp 9 so that movement of mass 9′ results in movement of clamp 9 between the position of first clamp 9 and the second position of clamp 9 and that movement of clamp 9 results in movement of mass 9′.

In other words, depending on the incline taken by stator 6, mass 9′ moves due to the effect of its weight which makes clamp 9 move. Clamp 9 moves to come into contact with textured contact area 8 or on the contrary to move away from textured contact area 8. Depending on the incline of stator 6, clamp 9 moves and rotor 5 is blocked at least in the first direction of rotation or it is free to rotate in the first direction of rotation and preferentially in both directions of rotation.

The incline of stator 6 corresponds to the angle that exists between a vector starting from the axis of rotation and directed towards outlet opening 6b of second end 2b of wire-like element 2 and the gravity vector. The vector representative of the incline is perpendicular to the direction of rotation of rotor 5. Stator 6 can be inclined upwards, inclined downwards or arranged horizontally.

When mass 9′ is fitted in a slide 10 as illustrated in FIGS. 2 to 8, it is advantageous for the direction of translation defined by slide 10 to be parallel to the vector representative of the incline. In even more advantageous manner, when stator 6 defines two openings 6a and 6b, the two openings are diametrically opposite one another along a diameter of rotor 5 and the two openings 6a and 6b define a parallel axis with the vector representative of the incline.

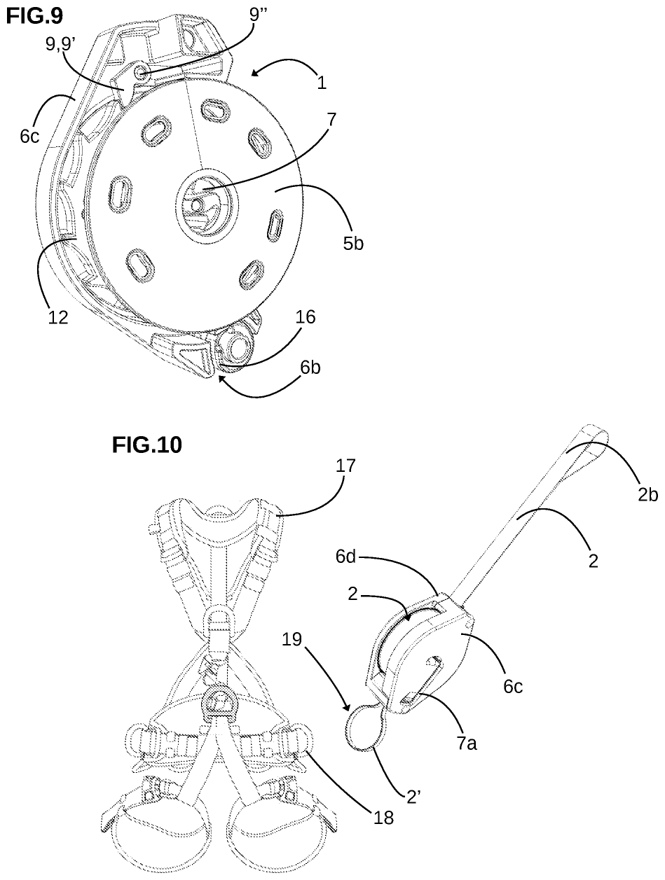

In the embodiment illustrated in FIGS. 2 to 8, clamp 9 is in the form of a pin that is fitted so as to move in a slide 10 arranged in stator 6, here more particularly in support 6′. It is advantageous to provide a pin mounted sliding in a slide 10 as the movement of pin 9 is well controlled. Other movements are possible, for example a clamp 9 mounted rotatably with a pin that moves towards or away from textured contact area 8 depending on the incline of stator 6 as illustrated in FIG. 9.

In the illustrated embodiments, mass 9′ and clamp 9 are formed by the same part. Mass 9′ and clamp 9 are monolithic and in a single piece. This configuration is more compact. As an alternative, mass 9′ and clamp 9 are two distinct parts, for example two parts connected by at least one gear. Mass 9′ can be rotatable whereas clamp 9 is movable in translation or vice versa. Other configurations are possible.

The embodiment illustrated in FIGS. 1 to 8 illustrates a stator with two openings 6a and 6b and a single wire-like element 2 that exits from stator 6 via the two openings 6a and 6b. Wire-like element 2 exits from stator 6 via these two openings 6a and 6b and rotation of the rotor causes elongation or shortening of the wire-like element via each of the two ends 2a/2b. This embodiment can be applied to the lanyard illustrated in FIG. 9.

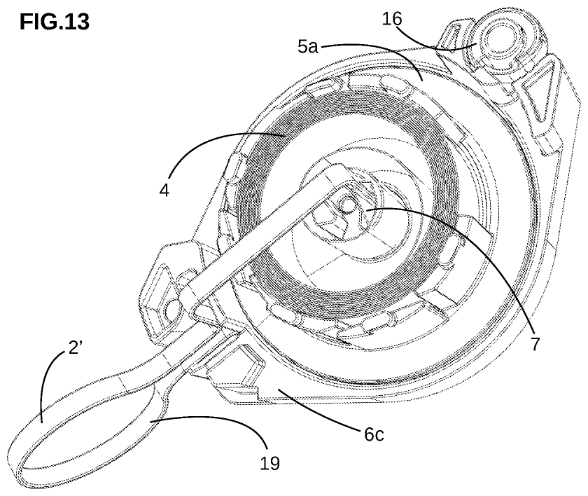

In the embodiments of FIGS. 10 to 13, first end 2a is fixed to rotor 5. Wire-like element 2, the length of which is modified by the rotation of rotor 5, exits only via opening 6b. The attachment point can be formed by stator 6 or by a second wire-like element fixed to stator 6. In the illustrated embodiment, the stator preferentially defines a first opening 6a receiving the second wire-like element to facilitate understanding of how the lanyard works and to prevent movement of the second wire-like element with respect to stator 6.

In the embodiment illustrated in FIGS. 2 to 8, slide 10 is arranged above second opening 6b. Slide 10 can also be arranged below second opening 6b by moving textured contact area 8 in the same way. Clamp 9 and mass 9′ are formed by one and the same part. In FIG. 3, a first vector representative of the incline is represented by a solid arrow starting from rotation shaft 7. When stator 6 is inclined upwards, i.e. the vector is inclined upwards, clamp 9 leaves textured contact area 8 and allows rotation of rotor 5 at least in the first direction of rotation. When stator 6 is inclined downwards, clamp 9 enters a cavity of textured contact area 8 and clamp 9 prevents rotation of rotor 5 at least in the first direction of rotation.

A second vector representative of the incline is represented by a broken arrow starting from rotation shaft 7. When stator 6 is inclined upwards, i.e. the vector is inclined upwards, clamp 9 moves and comes into contact with textured contact area 8 blocking at least the first direction of rotation of rotor 5. When stator 6 is directed downwards, clamp 9 moves away from textured contact area 8 and allows rotation of rotor 5 at least in the first direction of rotation. In the illustrated embodiment, rotation is free in both directions.

In an alternative embodiment that is not illustrated, slide 10 is mounted on stator 6 in diametrically opposite manner with respect to the axis of rotation of the rotor. The functioning is the opposite. In another alternative embodiment, mass 9′ and clamp 9 are connected by a cog-wheel, and the functioning is also reversed with respect to that explained just above. Fitting of the slide above first opening 6a and the use of a cog-wheel make it possible to have an identical functioning to that indicated previously. Different mechanical connections are possible between clamp 9 and mass 9′ for these two elements to move in the same way or in opposite directions with respect to the axis of rotation of the rotor. It is also possible to have a speed of movement of the clamp that is faster than, equal to or slower than the speed of movement of mass 9′. As indicated in the foregoing, the slide imposing a translation movement of clamp 9 can be replaced by a rotation shaft so as to have a rotatable clamp. Other movements are also possible.

Slide 10 can be partially formed in rotation shaft 7 defined from stator 6. The configuration of slide 10 makes it possible to define whether blocking of rotor 5 will be performed with a stator inclined upwards or downwards. Clamp 9 fitted in the central area of rotor 5 can be movable in translation, in rotation or with a more complex movement.

To make lanyard 1 easier to use, it is preferable to have a clamp 9 that is fitted movable in translation along an axis that is represented by a radius extending from the axis of rotation of rotor 5. In the illustrated configuration, clamp 9 is fitted in translation in the form of a diameter, a two-branch part connecting first opening 6a and second opening 6b.

It is also possible to have a clamp 9 that is fitted rotatable and that is connected to a mass 9′ forming a counterweight. The clamp illustrated in FIG. 3 is no longer movable in translation but in rotation around an axis of rotation that is perpendicular to the direction connecting the axis of rotation of rotor 5 and second opening 6b and perpendicular to the axis of rotation of rotor 5. In an alternative, clamp 9 is rotatable around an axis of rotation that is parallel to the axis of rotation of rotor 5. Depending on whether stator 6 is directed upwards or downwards, clamp 9 moves towards or away from rotor 5. There again, clamp 9 can be installed below or above first opening 6b or second opening 6b. It is also possible to install clamp 9 in any position around rotor 5. The shape of clamp 9 and its axis of rotation simply have to be modified to obtain blocking or rotation of the rotor with a specific orientation of stator 6 with respect to gravity. This configuration can also be installed inside the hollow area delineated by rotor 5 as replacement for a part of rotation shaft 7 or inside rotation shaft 7. To have a clamp that moves earlier or later when the stator changes incline, the direction of translation of the slide or the direction of rotation that define movement of mass 9′ and/or of clamp 9 simply have to be modified.

To preserve a compact, light-weight lanyard, it is preferable for the lanyard not to be used with heavy loads. As illustrated in FIGS. 1 to 8, it is advantageous for stator 6 not to be directly attached to its anchor point to avoid the force applied on the end of wire-like element 2 by the element fixed on second end 2b from applying too strong a force on clamp 9 and textured contact area 8. It is preferable for one end of wire-like element 2 to be fixed to the anchor point and for the other end to be fixed for example to a tool so that, in its maximum extension, reel 3 is not stressed and the force is exclusively supported by wire-like element 2. It is possible for the two openings 6a and 6b to be aligned or almost aligned with the direction of rotation of rotor 5. In advantageous manner, wire-like element 2 passes through a slot 5′ arranged tangent or almost tangent on rotor 5′.

In the particular case illustrated, spring 4 is a spiral-wound spring extending from the surface of stator 6 to be facing wire-like element 2 in the direction of its height.

It is also advantageous for reel 3 to be fitted movable with respect to wire-like element 2 when wire-like element 2 is taut. In this way, when wire-like element 2 is tensioned, the force is applied along the longitudinal axis of wire-like element 2 and no force or a reduced force is applied on reel 3. As an alternative, wire-like element 2 is fixed in pin-point manner to reel 3 so as not to transmit forces to reel 3.

In the embodiment illustrated in FIGS. 1 to 8, wire-like element 2 extends from the two openings 6a and 6b of stator 6 so that lengthening and shortening of wire-like element 2 take place on both sides of stator 6. However, it is not always desirable to have a reel 3 that moves away from or towards the two ends of wire-like element 2 with modulation of the length of wire-like element 2. The embodiment illustrated in FIGS. 9 to 13 presents a configuration where a single end of wire-like element 2 moves away from or towards stator 6 depending on the direction of rotation of rotor 5.

First end 2a of wire-like element 2 is fixed to rotor 5, for example by means of a closed loop passing round rotor 5. Second end 2b exits from reel 3 so that the effective length of wire-like element 2 is modified with the rotation of rotor 5. The others features are identical to those of the embodiment described in the foregoing and illustrated in FIGS. 1 to 8. The attachment point of lanyard 1 is no longer first end 2a of wire-like element 2 but an attachment point formed directly on stator 6 or preferentially a second wire-like element 2′ fixed to stator 6.

The force applied between second wire-like element 2′ and second end 2b of wire-like element 2 causes rotation of rotor 5 and elongation of wire-like element 2. In preferential manner, second wire-like element 2′ forms a loop that passes through the rotation shaft of rotor 5 and the loop forming first end 2a and passes round rotor 5.

This embodiment is advantageous as application of a higher force than a threshold value causing breaking of rotor 5 and/or stator 6 does not necessarily result in the mechanical connection between the attachment point and second end 2b being lost. The two loops are taken up in one another so that, in the event of impairment of the reel, the force between the two ends of wire-like element 2 is taken up by second wire-like element 2′. In case of breaking of the reel, the two loops of the two wire-like elements 2 and 2′ ensure the mechanical cohesion.

Rotation of rotor 5 does not have any influence on elongation or shortening of second wire-like element 2′. Only the effective length of wire-like element 2 is modified with the rotation of rotor 5. When a pull is exerted on second end 2b of wire-like element 2, reel 3 does not move away from the first end of wire-like element 2 or of second wire-like element 2′. As illustrated in FIGS. 8 and 9, the length of wire-like element 2 is only modified next to reel 3.

In the particular embodiments illustrated in FIGS. 9 to 13, a clamp element 16 is fitted on stator 6 to block wire-like element 2 in opening 2b of stator 6. Clamp element 16 is mounted movable between a first position blocking wire-like element 2 against stator 6 and a second position allowing lengthening or shortening of wire-like element 2 if the orientation of stator 6 allows. Blocking of wire-like element 2 by means of clamp element 16 is independent from the orientation of stator 6. Clamp element 16 can also be installed in a lanyard illustrated in FIGS. 1 to 8. Clamp element 16 is not configured to block the position of clamp 9 or of mass 9′, nor is it configured to prevent rotation of rotor 5.

It is advantageous to have a reel 3 that allows movement of rotor 5 in a single direction of rotation when clamp 9 is in contact with textured contact area 8. Depending on requirements, the direction of rotation allowed for rotor 5 can be winding of wire-like element 2 or unwinding of wire-like element 2. In the particular embodiment illustrated in FIGS. 2 to 8, the clamp is configured to only block the first direction of rotation of rotor 5.

To allow rotation of rotor 5 that is in contact with clamp 9, the shape of the head of clamp 9 and/or the shape of the patterns present on textured contact area 8 are adapted in known manner. In advantageous manner, textured contact area 8 presents a plurality of teeth 8a and/or of holes that have an asymmetric shape when observed in a cutting plane perpendicular to the direction of rotation of rotor 5. FIG. 2 illustrates a particular embodiment of teeth 8a and holes 8b of textured contact area 8. In the illustrated example, first slope 8c oriented in the unwinding direction is less steep than second slope 8d oriented in the winding direction of wire-like element 2. Second slope 8d prevents winding whereas first slope 8c pushes on clamp 9 to enable unwinding. A reversal of first and second slopes 8c and 8d is possible if it is desired to allow winding and prevent unwinding.

In the illustrated embodiment, when stator 6 is inclined to separate clamp 9 and textured contact area 8, rotor 5 can rotate in both directions of rotation. When stator 6 is inclined to place clamp 9 and textured contact area 8 in contact, rotor 5 can only rotate in the first direction of rotation for example to unwind wire-like element 2. In this particular case, the rope access technician still has the possibility of increasing the length of wire-like element 2 and spring 4 does not provide any force designed to reduce the length of wire-like element 2 as clamp 9 blocks rotor 5.

In the illustrated embodiment, blocking of the rotation of rotor 5 in a single direction of rotation is obtained by the asymmetrical profile of the teeth of textured contact area 8. It is possible to obtain an identical result using a head of clamp 9 having an asymmetrical head.

It is also possible to provide for the orientation of the head and/or the orientation of textured contact area 8 to be modifiable in order to define whether reel 3 has to block only the winding or unwinding direction of rotor 3. The head can be mounted rotatable so as to be able to be turned to modify the behaviour of reel 3 as indicated in the foregoing. It is also possible to provide a textured contact area that can be dismounted and turned.

In a particular embodiment, textured contact area 8 is fitted in fixed manner on rotor 5 or can be mounted fixedly on rotor 5. For example, the wall of rotor 5 is textured to define the different patterns that will collaborate with clamp 9 to block rotor 5. However, it may happen that, following an improper movement or on account of a particularly heavy tool, the force applied on clamp 9 and on textured contact area 8 is higher than the threshold value resulting in impairment or even breaking of certain teeth or of the head.

When the force applied on the blocking system formed by clamp 9 and the textured contact area is higher than a threshold value and to prevent the blocking system from being broken, it is preferable to install a mechanical disconnection device between clamp 9 and rotor 5 or its drum. The mechanical disconnection device is configured to perform mechanical connection between rotor 5 and clamp 9 when the force is lower than the threshold value and to mechanically disconnect rotor 5 and clamp 9 when the force reaches the threshold value. Below the threshold value, clamp 9 blocks rotor 5. Above the threshold value, clamp 9 is in the blocking position but rotor 5 has the possibility of winding wire-like element 2.

To obtain such a result, it is possible to work on the shape of the teeth and/or on the head of clamp 9. However, this solution is complicated to implement and evolves with the wear of the blocking system. It is particularly advantageous to have an intermediate connector 11 between rotor 5 and textured contact area 8. Intermediate connector 11 provides the mechanical connection between rotor 5 and textured contact area 8 and is configured to deform elastically so as to eliminate the mechanical connection between rotor 5 and textured contact area 8 when the force between these two elements is higher than the threshold value.

In other words, when the force between rotor 5 and textured contact area 8 is lower than the threshold value, rotor 5 and textured contact area 8 move in similar manner and movement of the one results in movement of the other and blocking of the one results in blocking of the other. On the other hand, when the threshold force is reached, intermediate connector 11 eliminates the mechanical connection between rotor 5 and textured contact area 8 enabling movement of rotor 5 independently from textured contact area 8 until the force drops back below the threshold force value.

In the embodiment illustrated in FIGS. 1 to 8, when the threshold force is reached for example due to a too heavy tool connected on one side or the other of the reel, intermediate connector 11 enables rotor 5 to unwind wire-like element 2 completely so that the force is taken up between the two ends of wire-like element 2 without any stress being placed on reel 3. In the embodiment illustrated in FIGS. 9 to 13, the force is taken up by reel 3.

In the embodiment illustrated in FIG. 2, a ring 12 is fitted on rotor 5. Ring 12 has an outer crown defining textured contact area 8 and an inner crown. The inner crown is formed by a plurality of teeth 13 that extend towards the centre of ring 12 and are inserted in a plurality of cavities of a cog-wheel 14 mounted in fixed manner on rotor 5. Cog-wheel 14 is provided with teeth and cavities on its outer wall.

Teeth 13 are arranged movable with respect to the outer crown by means of flexible arms 15. When rotor 5 tries to rotate and clamp 9 blocks textured contact area 8, rotor 5 applies a force on flexible arms 15 which deform to allow movement of rotor 5 with respect to clamp 9. In the illustrated example, flexible arms 15 are mounted on ring 12 but it is possible to mount the flexible arms on cog-wheel 14. The inner crown is then formed by teeth and cavities that cooperate with the teeth arranged on the flexible arms.

In an alternative embodiment that is not illustrated, the mechanical disconnection device is installed between clamp 9 and stator 6 so that when the threshold force is reached, clamp 9 pivots and allows rotor 5 to rotate to unwind wire-like element 2. This embodiment is more complex to achieve as two distinct movements of clamp 9 are required. It is also possible to define the mechanical disconnection device by means of first and second slopes 8c and 8d. There again, practical implementation is more complex. For example, slide 10 is mounted rotatable to exit from the teeth. Rotation is only allowed when the threshold force is reached.

In the embodiment illustrated in FIGS. 2, 3 and 4, cog-wheel 14 is formed by rotor 5, but it is possible to form the mechanical disconnection device as a part in its own right that is fixed onto rotor 5 and defines cog-wheel 14, teeth 13 mounted on flexible arms 15 and crown 12.

In the embodiment illustrated in FIGS. 5, 6, 7 and 8, spring 4 and wire-like element 2 are arranged in the same plane perpendicular to the axis of rotation of rotor 5. As an alternative, spring 4 and wire-like element 2 belong to two different planes perpendicular to the direction of rotation of rotor 5.

In the illustrated configuration, rotor 5 is formed by several parts that rotate with respect to stator 6 when winding or unwinding of wire-like element 2 takes place. In the configuration presented, rotor 5 is formed by a bottom part 5a and a top part 5b. Spring 4 is enclosed between the two parts of rotor 5 and defines a cavity containing rotation shaft 7. Side wall 5c of rotor 5 is defined by one or the other of the parts or by both parts.

In the embodiment illustrated in FIG. 7, spring 4 and wire-like element 2 are separated by a side wall 5c of rotor 5. Side wall 5c extends in a direction parallel to the axis of rotation of rotor 5.

In the particular embodiment illustrated in FIG. 1, stator 6 is formed by at least two parts. Stator 6 comprises a support 6c receiving rotor 5 and defining the two outlet openings 6a/6b of the two strands of wire-like element 2. Support 6c defines the anchor point of spring 4. Stator 6 is closed by a cover 6d that prevents extraction of rotor 5 and that protects clamp 9 and textured contact area 8. Support 6c can be devoid of outlet 6a.

FIGS. 2 to 9 illustrate a particular embodiment with support 6c that defines a part of the rotation shaft. The other part of the rotation shaft is formed by cover 6b. Rotor 5 is mounted rotatable around the rotation shaft between support 6a and cover 6b.

When rotor 5 is formed by several parts, the part that forms side wall 5 or at least a third of side wall 5c is associated with textured contact area 8 as the force provided by wire-like element 2 is mainly transmitted to side wall 5a. It is advantageous for textured contact area 8 to be mounted on the part that defines at least 50% of side wall 5c and preferentially at least the whole of side wall 5c.

In the illustrated embodiment, bottom part 5a of rotor 5 is fixed to top part 5b of rotor 5 by means of a set of slots and grooves. The bottom and top parts are also held together by means of stator 6.

FIG. 4 illustrates a particular embodiment of the reel with rotor 5 mounted on the support of stator 6 without wire-like element 2. Side wall 5c extends over the whole height of rotor 5 up to two circular plates that limit the storage of wire-like element 2.

FIG. 4 illustrates a particular embodiment in which side wall 5c does not form a cavity of the circular cross-section. Side wall 5c is apertured to allow one end of spring 4 to pass in order to fix spring 4 to rotor 5 and preferentially on side wall 5c.

Side wall 5c is also apertured in order to let a part of wire-like element 2 pass thereby enabling wire-like element 2 to be wound and unwound in the direction of rotation and to let reel 3 slide along wire-like element 2 when wire-like element 2 is stretched fully taut. This also enables reel 3 not to be stressed when a strong force is applied between the two ends of wire-like element 2 stretching wire-like element 2.

In the configuration illustrated in FIGS. 1 to 8, there is a single wire-like element 2. When rotation of rotor 5 takes place, the two ends of wire-like element 2 move in one direction or in the other direction depending on the axis of rotation of the rotor. A tractive force applied between the two opposite ends 2a and 2b of wire-like element 2 to increase the effective length of wire-like element 2 makes rotor 5 rotate. It is advantageous to place rotor 5 in the centre of wire-like element 2 in order to have the maximum amplitude of extension of wire-like element 2 between its extended position and its wound position. Rotation of rotor 5 in one direction or the other results in elongation or shortening of wire-like element 2. In its maximum extension, the force applied between the two ends of wire-like element 2 is not transmitted to the reel which prevents the winding mechanism from being damaged. The force take-up is only supported by wire-like element 2.

The illustrated configurations are particularly advantageous to form gear sling lanyards, rope ascent foot loops and other types of lanyards where the length of the lanyard is detrimental when it is not used and/or for which it is advantageous to be able to adjust the length quickly.

One application of a gear sling lanyard is illustrated in FIG. 10 for the embodiment with two wire-like elements 2 and 2′, but the embodiment according to FIG. 1 to 8 or 9 is also possible. The tool is fixed to end 2b of wire-like element 2. The attachment point of lanyard 1 is fixed to a harness 17.

The attachment point of lanyard 1 is secured to a roping harness 17, more particularly to an anchorage ring 18 of harness 17. Anchorage ring 18 can be a ring fitted on the belt of harness 17 or on a shoulder strap. Preferentially, the attachment point forms a first loop 19 enabling a connector to be installed mechanically connecting roping harness 17 and lanyard 1. As an alternative, anchorage ring 18 is removable which enables loop 19 of the attachment point to be installed, or loop 19 of the attachment point is large enough to pass through anchorage ring 18 and to close on itself to mechanically connect the lanyard and harness. As indicated in the foregoing, the attachment point can be formed by wire-like element 2, second wire-like element 2′ or stator 6.

To obtain a gear sling lanyard that is easy to use, it is advantageous for lanyard 1 to be configured so that when stator 6 is inclined upwards, clamp 9 allows rotation of rotor 5 at least in the first direction of rotation, and that when stator 6 is inclined downwards, clamp 9 prevents rotation of rotor 5 in the first direction of rotation. The first direction of rotation is unwinding of wire-like element 2. When stator 6 is inclined downwards, this corresponds to a tool suspended by means of the lanyard, and it is unpleasant if the lanyard unwinds and the tool ends up on the rope access technician's knees or feet. When stator 6 is inclined upwards, this corresponds to a tool that is being used, and the rope access technician must not be impeded by preventing wire-like element 2 from unwinding.

More preferentially, when stator 6 is inclined downwards, clamp 9 blocks rotation of rotor 5 to prevent unwinding of wire-like element 2 without preventing winding of wire-like element 2. As the rope access technician brings the tool back down, the reel progressively absorbs the excess wire-like element 2. The rope access technician can let go of the tool before all of the wire-like element has been absorbed and the reel rewinds the rest of the wire-like element.

More preferentially, when stator 6 is inclined downwards, clamp 9 allows rotation of rotor 5 in both directions of rotation.

In the embodiment illustrated in FIGS. 10, 12 and 13, it is advantageous for reel 3 to be close to the harness so that the rope access technician does not have to support the weight of the reel in his repeated movements using the tool. The embodiment of FIGS. 10, 12 and 13 is preferred to form a gear sling lanyard.

As indicated in the foregoing, clamp 9 can be located in any position and its mechanical connection with mass 9′ can be of any kind provided that the above-mentioned functioning is able to be obtained.

II is not necessary for the user to press on a button to engage or disengage clamp 9. The latter is activated directly depending on the orientation of stator 6 in space.

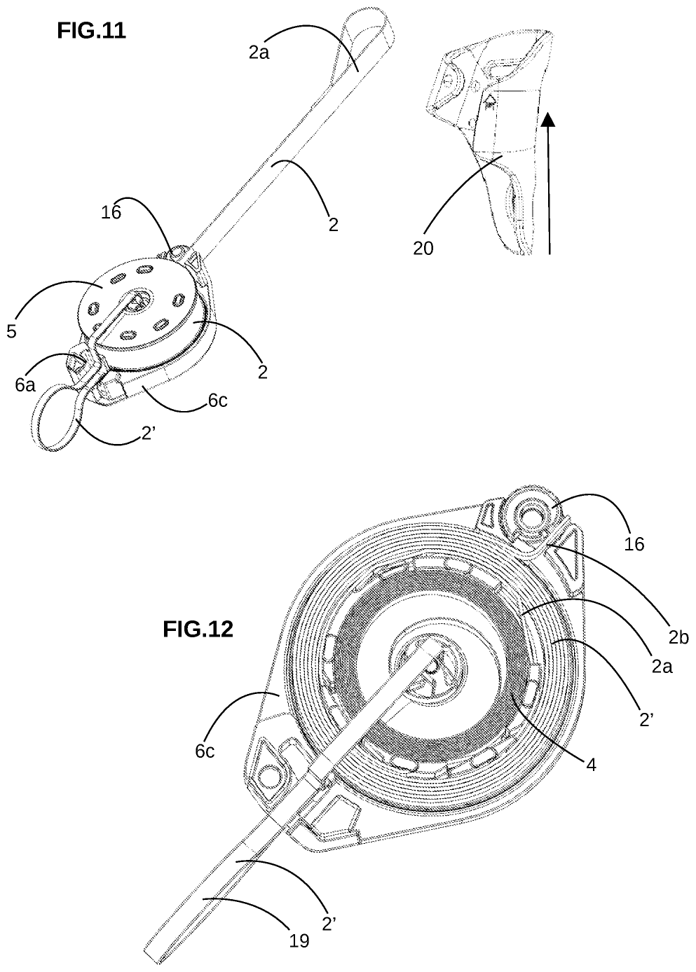

An application of the lanyard as foot loop for rope ascent is illustrated in FIG. 11 for the embodiment with two wire-like elements 2 and 2′, but use of the embodiment according to FIG. 1 to 8 or 9 is possible. The tool is fixed to the end 2b of wire-like element 2. The attachment point of lanyard 1 is fixed to a harness 17.

In one configuration, second end 2b is fixed to a rope clamp device 20 and the attachment point forms a foot loop, i.e. a ring designed to receive the rope access technician's foot. The attachment point can be formed by first end 2a of wire-like element 2, by loop 19 formed by second wire-like element 2′ or by a ring fixed to stator 6 or to loop 19. In another configuration, second end 2b forms the foot loop or the foot loop is fixed to second end 2b. The attachment point is fixed to the rope clamp.

Rope clamp 20 is a device that is configured to move along the rope in one direction only, here the ascent direction (illustrated by an arrow). Rope clamp 20 can be a cam-based clamp, for example a rope clamp marketed under the Basic or Crolles trade name. Rope clamp 20 can also be a device with angled teeth, for example a rope clamp marketed under the Tibloc trade name. It is also possible to use a self-locking knot, for example of Prusik type. A configuration of a foot loop for a rope ascent device is illustrated in FIG. 11 with a rope clamp 20 designed to be fixed to the second end of wire-like element 2

Reel 3 is configured so that when the incline of stator 6 corresponds to the foot loop situated under the rope clamp, the clamp prevents rotation of the rotor in the winding direction of wire-like element 2. When the incline of stator 6 corresponds to the foot loop situated above rope clamp 20, rope clamp 20 allows rotation of rotor 5 in the winding direction of wire-like element 2.

Different configurations are possible depending on the end of reel 3 connected to rope clamp 20 and to the foot loop and depending on the position of clamp 9 with respect to rotor 5.

In an advantageous embodiment as it is compact and simple to implement, clamp 9 and mass 9′ are in a single piece and assembled able to move in translation above or below first opening 6a. Second end 2b is fixed to rope clamp 20 as illustrated in FIG. 10.

The reel is configured so that when stator 6 is inclined upwards, clamp 9 allows winding of wire-like element 2 and preferentially winding and unwinding of wire-like element 2 by rotation of rotor 5. When stator 6 is inclined downwards, clamp 9 prevents rotation of rotor 5 in the winding direction of wire-like element 2.

When the assembly of rope clamp 20 and the foot loop on the ends of lanyard 1 is inverted, the conditions on the incline of stator 6 have to be inverted. The vector defining the incline does in fact connect the axis of rotation and opening 6b and second end 2b can be connected to rope clamp 2 or to the foot loop.

When performing rope ascent, the rope access technician applies his weight on the foot loop which corresponds to a considerable force. It is advantageous to use the configuration illustrated in FIGS. 1 to 8 and more preferentially with the mechanical disconnection device presented in the foregoing. If wire-like element 2 is not stretched fully taut, the mechanical disconnection device allows rotation of the rotor with respect to the stator until wire-like element 2 is fully taut. Once wire-like element 2 is fully taut, the force is supported between the two ends of wire-like element 2 without too great a stress being applied on reel 3. It is then possible to have a reel of moderate size and weight supporting the weight of the rope access technician and with a fixed length. To have a foot loop of adjustable length, rotation of the rotor has to be blocked in both directions and it is necessary to have a rotor 5 and clamp 9 that are sufficiently robust to withstand the force.

On the contrary, according to the embodiment of FIGS. 11 to 13, all the components of reel 3 have to be dimensioned to support the weight of the rope access technician as the wire-like element is connected to rotor 5. The length of the lanyard can be made to vary.

FIGS. 10 to 13 illustrate the use of a locking cam 16 that is configured to block the second end of wire-like element 2b on stator 6 or against stator 6.

Locking cam 16 can be used in a gear sling lanyard to prevent the rope access technician from applying a force to counteract the force of spring 4 that tends to wind wire-like element 2.

It is also possible to use a locking cam 16 in a rope ascent foot loop. Locking cam 16 is configured to block second end 2b of wire-like element 2. Locking cam 16 is located up-line from rotor 5. When wire-like element 2 is blocked by the locking cam, the force applied between loop 19 and second end 2b is not applied on rotor 5 and on clamp 9. Loop 19 is not pressing on the rotor so that the force take-up is performed by means of stator 6. The stator is advantageously made from metal.

1. Adjustable-length lanyard comprising:
a wire-like element having a first end and a second end opposite the first end;
a reel with a spring comprising a rotor and a stator, the rotor being mounted rotatable with respect to the stator in two opposite directions of rotation, at least the second end of the wire-like element exiting from the reel with the spring, the wire-like element being functionally linked to the rotor so that rotation of the rotor results in winding of the wire-like element and that unwinding of the wire-like element makes the rotor rotate, rotation of the rotor modulating the effective distance between the first end and the second end of the wire-like element, and so that if no force is applied on the wire-like element, the spring causes winding of the wire-like element;
an attachment point designed to secure the lanyard to another element; characterised in that:
a textured contact area is fixed to the rotor;
a clamp is fitted movable between a first position of the clamp and a second position of the clamp, the first position of the clamp corresponding to one of the positions of the clamp chosen from the clamp in contact with the textured contact area to prevent rotation of the rotor in at least a first of the two directions of rotation and the clamp at a distance from the textured contact area to allow rotation of the rotor at least in the first of the two directions of rotation, the second position of the clamp corresponding to the other of the two positions of the clamp;
a mass mounted movable with respect to the rotor and to the stator, the mass moving under the effect of its weight according to the incline of the stator with respect to the gravity vector, the mass being functionally linked to the clamp so that movement of the mass results in movement of the clamp between the first position of the clamp and the second position of the clamp and that movement of the clamp results in movement of the mass.

2. Adjustable-length lanyard according to claim 1 wherein the reel with the spring is able to rotate in the two opposite directions of rotation when the clamp is at a distance from the textured contact area.

3. Adjustable-length lanyard according to claim 1 wherein the textured contact area defines asymmetric teeth and/or the clamp defines an asymmetric head in a cutting plane perpendicular to the axis of rotation of the rotor to allow rotation of the rotor with respect to the stator in the other of the two directions of rotation when the clamp is in contact with the textured contact area.

4. Adjustable-length lanyard according to claim 1 wherein the textured contact area is mounted rotatable with respect to the rotor when a force applied between the rotor and the textured contact area is greater than a threshold force so as to allow rotation of the rotor in the at least one of the two directions of rotation when the clamp is in contact with the textured contact area.

5. Adjustable-length lanyard according to claim 1 comprising a ring that has an outer crown and an inner crown, one of the inner crown and outer crown forming the textured contact area, the other of the inner crown and outer crown forming a mechanical disconnection device with the rotor when a threshold force is reached.

6. Adjustable-length lanyard according to the claim 1 wherein the rotor and the other of the inner crown and outer crown define a first set of teeth and a second set of teeth, the first set of teeth and/or the second set of teeth being elastically deformable.

7. Adjustable-length lanyard according to claim 1 wherein the clamp is mounted movable in translation in a slide or wherein the clamp is mounted movable in rotation around a rotation shaft.

8. Adjustable-length lanyard according to claim 1 wherein the clamp (9) and mass are monolithic or in a single piece.

9. Adjustable-length lanyard according to claim 1 wherein the stator defines a first outlet opening for the first end of the wire-like element and a second outlet opening for the second end, the first and second outlet openings being diametrically opposite one another forming a diameter of the rotor and wherein the mass moves mainly or exclusively along an axis parallel to the axis connecting the first and second outlet openings.

10. Adjustable-length lanyard according to claim 1 wherein the wire-like element passes through a slot of the rotor, and when the wire-like element is fully stretched between the first end and the second end, the reel is movable along the wire-like element.

11. Adjustable-length lanyard according to claim 1 wherein the first end of the wire-like element forms a ring around the rotor and is fixed to the rotor and a second wire-like element is fixed to the stator, wherein the second wire-like element has a second end forming a second loop passing through the first loop and through the rotor, rotation of the rotor not having any influence on elongation or shortening of the second wire-like element.

12. Roping harness comprising a variable-length lanyard according to claim 1, the attachment point being fixed to an anchor ring of the roping harness.

13. Roping harness according to claim 12 wherein a tool is fixed to the second end of the wire-like element, the second end of the wire-like element exiting from the stator via a second opening and wherein the clamp is arranged to prevent rotation of the rotor in the first direction of rotation when the vector connecting the axis of rotation of the rotor and the second opening is directed upwards, and to allow rotation of the rotor in the first direction of rotation when the vector connecting the axis of rotation of the rotor and the second opening is directed downwards, the first direction of rotation corresponding to winding of the wire-like element.

14. Method for use of a roping harness according to claim 12 comprising the following steps:
providing said roping harness;
directing the stator downwards so that the clamp blocks the rotor to prevent unwinding of the wire-like element;
directing the stator upwards so that the clamp unblocks the rotor and pulling on the wire-like element to unwind the wire-like element from the rotor and to move the first end away from the second end.

15. Rope ascent device comprising a rope clamp designed to be fixed to a rope and a variable-length lanyard according to claim 1 and wherein the rope clamp is fixed to the attachment point of the variable-length lanyard and a ring designed to receive a rope access technician's foot is fixed to or is formed by the second end of the wire-like element, the second end exiting from the stator via a second opening and wherein the clamp is arranged to prevent rotation of the rotor in the first direction of rotation when the vector connecting the axis of rotation of the rotor and the second opening is directed downwards, and to allow rotation of the rotor in the first direction of rotation when the vector connecting the axis of rotation of the rotor and the second opening is directed upwards, the first direction of rotation corresponding to winding of the wire-like element.

16. Rope ascent device comprising a rope clamp designed to be fixed to a rope and a variable-length lanyard according to claim 1 and wherein the rope clamp is fixed to the second end of the wire-like element and a ring designed to receive a rope access technician's foot is fixed to or is formed by the attachment point of the variable-length lanyard, the second end exiting from the stator via a second opening and wherein the clamp is arranged to prevent rotation of the rotor in the first direction of rotation when the vector connecting the axis of rotation of the rotor and the second opening is directed upwards, and to allow rotation of the rotor in the first direction of rotation when the vector connecting the axis of rotation of the rotor and the second opening is directed downwards, the first direction of rotation corresponding to winding of the wire-like element.
